(19) United States
(12) Patent Application Publication
(10) Pub. No.: US 2021/0393069 A1
(43) Pub. Date: Dec. 23, 2021

(54) A METHOD AND APPARATUS FOR PRODUCING A BEVERAGE

(71) Applicant: James Finlay Limited, Aberdeenshire (GB)

(72) Inventors: Nicole Toal, Aberdeenshire (GB); Ottilie Cunningham, Aberdeenshire (GB); Frieda Dehrmann, Aberdeenshire (GB); Wolfgang Tosch, Aberdeenshire (GB); Daniel Longman, Leicester (GB); Jonathan Ashbridge, Leicester (GB); Trevor Cowley, Aberdeenshire (GB)

(21) Appl. No.: 17/281,891

(22) PCT Filed: Oct. 1, 2019
(86) PCT No.: PCT/EP2019/076648

§ 371 Date: Mar. 31, 2021

(30) Foreign Application Priority Data
Oct. 2, 2018 (GB) 1816062.2

(51) Int. Cl. A47J 31/06; A47J 31/00; A47J 31/60; A47J 31/52

(52) U.S. Cl. CPC A47J 31/0615; A47J 31/002; A47J 31/52; A47J 31/0605; A47J 31/60

(57) ABSTRACT

A method for producing a beverage, for example cold-brewed tea or cold-brewed coffee, comprises exposing flavour materials (23), for example tea leaves or ground coffee beans, to hot water or steam to steep the flavour materials (23), circulating a mixture of the steeped flavour materials (23) and cold water in a brewing chamber (16), and dispensing the mixture through a filter device (18) to provide the beverage.

### TECHNICAL FIELD

The present disclosure relates generally to a method and apparatus for producing a beverage, and in particular a cold-brewed beverage. Embodiments of the present disclosure relate in particular, but not exclusively, to a method and apparatus for producing cold-brewed tea or cold-brewed coffee.

### TECHNICAL BACKGROUND

Cold brewing is a method that can be used to produce tea, coffee or other beverages without the use of hot water. In a typical static cold brewing method, tea leaves, ground coffee beans or other suitable flavour materials are steeped in cold water for an extended period of time, possibly up to 24 hours, to release flavours. Cold brewing tends to produce a different flavour profile than conventional hot brewing methods. However, the time taken to produce a beverage using cold brewing methods has tended to limit the uptake of cold brewing and embodiments of the present disclosure seek to address this shortcoming.

### SUMMARY OF THE DISCLOSURE

According to a first aspect of the present disclosure, there is provided a method for producing a beverage, the method comprising:
(i) exposing flavour materials to hot water and/or steam to steep the flavour materials;
(ii) circulating a mixture of the steeped flavour materials and cold water in a brewing chamber; and
(iii) dispensing the mixture through a filter device to provide the beverage.

According to a second aspect of the present disclosure, there is provided an apparatus for producing a beverage, the apparatus comprising a hot water supply, a brewing chamber including a circulating device, a filter device and a control unit, wherein the control unit is operable to:
operate the hot water supply to expose flavour materials to hot water and/or steam to steep the flavour materials; and
operate the circulating device to circulate a mixture of the steeped flavour materials and cold water in the brewing chamber;
wherein the apparatus is arranged to dispense the mixture through the filter device to provide the beverage.

The method and apparatus produce a beverage with optimum flavour characteristics and ready for immediate consumption. The beverage is produced quickly, typically in around two minutes or less, which is significantly quicker than conventional static cold-brewing methods. The initial exposure of the flavour materials to hot water and/or steam to steep the flavour materials helps to initiate the release of flavour substances from the flavour materials. The release of flavour substances from the flavour materials is further promoted and enhanced by the subsequent circulation of the mixture of steeped flavour materials and cold water in the brewing chamber before the resulting mixture is dispensed through the filter device to separate the liquid and solid components of the mixture and thereby produce a cold-brewed beverage.

The flavour materials preferably comprise plant materials. The plant materials may include teas, coffee, herbs or spices. The plant materials may comprise tea leaves to produce cold-brewed tea or ground coffee beans to produce cold-brewed coffee. It will, however, be apparent to one of ordinary skill in the art that other plant materials or flavour materials can be used.

The hot water or steam may have a temperature between approximately 40° C. and approximately 100° C. In embodiments in which step (i) comprises exposing the flavour materials to hot water, the hot water may have a temperature between approximately 40° C. and approximately 90° C. The use of hot water and/or steam with a temperature in these ranges helps to maximise the initial release of flavour substances from the flavour materials and may help to reduce microbial contamination (if any) of the flavour materials.

The cold water is typically at ambient temperature or room temperature and may have a temperature between 2° C. and 20° C. The use of cold water with a temperature in this range ensures that the flavour materials are cooled after the initial steeping to optimise the release of flavour substances.

In a first embodiment, step (i) may further comprise draining residual hot water after steeping the flavour materials. Thus, residual water not absorbed by the flavour materials during steeping is removed prior to step (ii) in which only the mixture of steeped flavour materials and cold water is circulated in the brewing chamber.

In a second embodiment, step (ii) may comprise circulating a mixture of the steeped flavour materials, hot water and cold water in the brewing chamber. In this second embodiment, residual hot water not absorbed by the flavour materials is circulated in the brewing chamber with the steeped flavour materials and the cold water.

It will be understood that the first embodiment tends to produce a beverage with a lower temperature than the second embodiment due to the removal of residual hot water before the mixture of steeped flavour materials and cold water is circulated in the brewing chamber.

Step (i) may comprise exposing the flavour materials to hot water in an amount from 5 to 40 vol. % of the total water content of the beverage. In some embodiments, step (i) may comprise exposing the flavour materials to hot water in an amount from 8 to 25 vol. % of the total water content of the beverage.

Step (ii) may be performed using cold water in an amount from 60 to 95 vol. % of the total water content of the beverage. In some embodiments, step (ii) may be performed using cold water in an amount from 75 to 92 vol. % of the total water content of the beverage.

It will, thus, be apparent that the volume of cold water is greater than the volume of hot water.

The beverage may comprise from 4 to 35 grams of flavour materials per litre of the total water content of the produced beverage.

In one non-limiting example that may be suitable for producing a single-serve beverage, step (i) may comprise providing 2 to 20 g of flavour materials, more typically 2 to 15 g of flavour materials, and may comprise adding 10 to 100 ml of hot water, more typically 20 to 80 ml of hot water, to the flavour materials; and step (ii) may comprise adding 200 to 450 ml of cold water to the brewing chamber, and more typically between 250 and 400 ml of cold water to the brewing chamber.

Step (i) may comprise exposing the flavour materials to the hot water or steam for a period of 5 to 60 seconds, possibly 5 to 30 seconds, or possibly 5 to 20 seconds. The steeping time is thus relatively short and ensures that the flavour materials are not heated for an extended period of time which might release unwanted flavour substances, and which might, for example, result in a beverage which has a bitter taste.

Step (ii) may comprise inducing pressure variations in the mixture in the brewing chamber. The pressure variations may result in the formation of microbubbles and/or vacuum pockets in the mixture. The pressure variations may be sufficient to cavitate the mixture in the brewing chamber, and thus step (ii) may comprise cavitating the mixture in the brewing chamber. Inducing pressure variations in the mixture enhances the release of flavour substances from the flavour materials in a very short period of time and contributes to the production of a beverage with optimum flavour characteristics.

Step (ii) may comprise circulating the mixture for 10 to 150 seconds, possibly 10 to 100 seconds, or possibly 20 to 60 seconds. The circulating step is thus relatively short in comparison to the time periods involved in conventional static cold-brewing methods and provides for optimum release of flavour substances from the flavour materials.

Step (ii) may comprise circulating the mixture using a rotary device.

The rotary device may comprise an impeller.

The rotary device may comprise a cylindrical drum having a circumferentially extending drum wall. The circumferentially extending drum wall may include a plurality of apertures or perforations which may extend in the radial direction through the circumferentially extending drum wall. The apertures or perforations may be distributed uniformly across the circumferentially extending drum wall. The apertures or perforations allow the mixture to flow between the interior and exterior of the cylindrical drum through the circumferentially extending drum wall.

The rotary device may be configured to induce pressure variations in the mixture in the brewing chamber. For example, the rotary device may be configured to induce the formation of microbubbles and/or vacuum pockets in the mixture in the brewing chamber and/or to cavitate the mixture in the brewing chamber. This promotes the release of flavour components/substances from the flavour materials whilst minimising the release of astringents.

Step (ii) may comprise rotating the rotary device at a rotational speed of 500 to 5,000 revolutions per minute, possibly 1,000 to 4,000 revolutions per minute, or possibly 2,000 to 3,000 revolutions per minute. A rotational speed within this range is particularly suitable for promoting the release of flavour components/substances from the flavour materials, for example by inducing pressure variations in the mixture in the brewing chamber that result in the formation of microbubbles and/or vacuum pockets in the mixture and/or that cavitate the mixture in the brewing chamber.

The method may further comprise, prior to step (i), exposing the flavour materials to cold water. The cold water is typically at ambient temperature or room temperature and may have a temperature between 2° C. and 20° C. Exposing the flavour materials to cold water prior to step (i) may help to avoid or minimise scorching or scalding of the flavour materials when they are exposed to the hot water and/or steam and may thereby help to minimise or eliminate the release of unwanted flavour substances from the flavour materials.

The method may further comprise:
(iv) circulating water and/or steam through the brewing chamber to clean the brewing chamber.

After the mixture has been dispensed through the filter device to provide the beverage, it is expected that some residual flavour materials and/or residual liquid beverage may remain in the brewing chamber, for example attached to the interior surfaces of the brewing chamber and other components within the brewing chamber. Performing a cleaning cycle in which water and/or steam is circulated through the brewing chamber allows any residual flavour materials and/or residual liquid beverage to be removed from the brewing chamber before a subsequent brewing cycle is performed. This ensures that the beverage produced during each brewing cycle has optimum flavour characteristics and that there is no contamination with flavour materials and/or liquid beverage from a previous brewing cycle.

The method may comprise loading the flavour materials into the filter device and step (i) may comprise exposing the flavour materials in the filter device to the hot water and/or steam to steep the flavour materials. The flavour materials can be easily and conveniently loaded into the filter device before they are steeped whilst positioned in the filter device.

In some embodiments, the method may comprise positioning the filter device at a location in communication with the brewing chamber and performing steps (i) to (iii) at said location. Performing all steps of the method at the same location provides a simple method for producing a beverage.

In other embodiments, the method may comprise positioning the filter device at a first location, remote from the brewing chamber, and performing step (i) at the first location. The method may further comprise repositioning the filter device containing the steeped flavour materials at a second location in communication with the brewing chamber and performing steps (ii) and (iii) at the second location. Performing step (i) at a first location and steps (ii) and (iii) at a second location ensures that heat input at the second location, from the hot water, is minimised.

### BRIEF DESCRIPTION OF THE DRAWINGS

FIG. 1 is diagrammatic cross-sectional side view of a first embodiment of an apparatus for producing a beverage illustrating the step of attaching a removable filter loaded with flavour materials;

FIG. 2 is a diagrammatic view of the apparatus of FIG. 1 and illustrates the exposure of the flavour materials to hot water to steep the flavour materials;

FIG. 3 is a diagrammatic view of the apparatus of FIGS. 1 and 2 illustrates the introduction of cold water into a brewing chamber;

FIG. 4 is a diagrammatic view of the apparatus of FIGS. 1 to 3 and illustrates the circulation of the steeped flavour materials, hot water and cold water in the brewing chamber;

FIG. 5 is a diagrammatic view of the apparatus of FIGS. 1 to 4 and illustrates dispensing of the mixture from the brewing chamber to produce the beverage;

FIG. 6 is a diagrammatic view of the apparatus of FIGS. 1 to 5 and illustrates a cleaning cycle;

FIGS. 7 and 8 are diagrammatic views of the apparatus of FIGS. 1 to 6 and illustrate the use of a cleaning filter to perform the cleaning cycle

FIG. 9 is a diagrammatic cross-sectional side view of a second embodiment of an apparatus for producing a beverage following attachment of a removable filter loaded with flavour materials and ready for use;

FIGS. 10 and 11 are diagrammatic views of the apparatus of FIG. 9 and illustrate the exposure of the flavour materials to hot water to steep the flavour materials;

FIGS. 12 to 13 are diagrammatic views of the apparatus of FIGS. 9 to 11 and illustrate the introduction of cold water into a brewing chamber;

FIG. 14 is a diagrammatic view of the apparatus of FIGS. 9 to 13 and illustrates the circulation of the steeped flavour materials, hot water and cold water in the brewing chamber;

FIG. 15 is a diagrammatic view of the apparatus of FIGS. 9 to 14 and illustrates dispensing of the mixture from the brewing chamber to produce the beverage; and

FIGS. 16 to 18 are diagrammatic views of the apparatus of FIGS. 9 to 15 and illustrate a cleaning cycle.

### DETAILED DESCRIPTION OF EMBODIMENTS

Embodiments of the present disclosure will now be described by way of example only and with reference to the accompanying drawings.

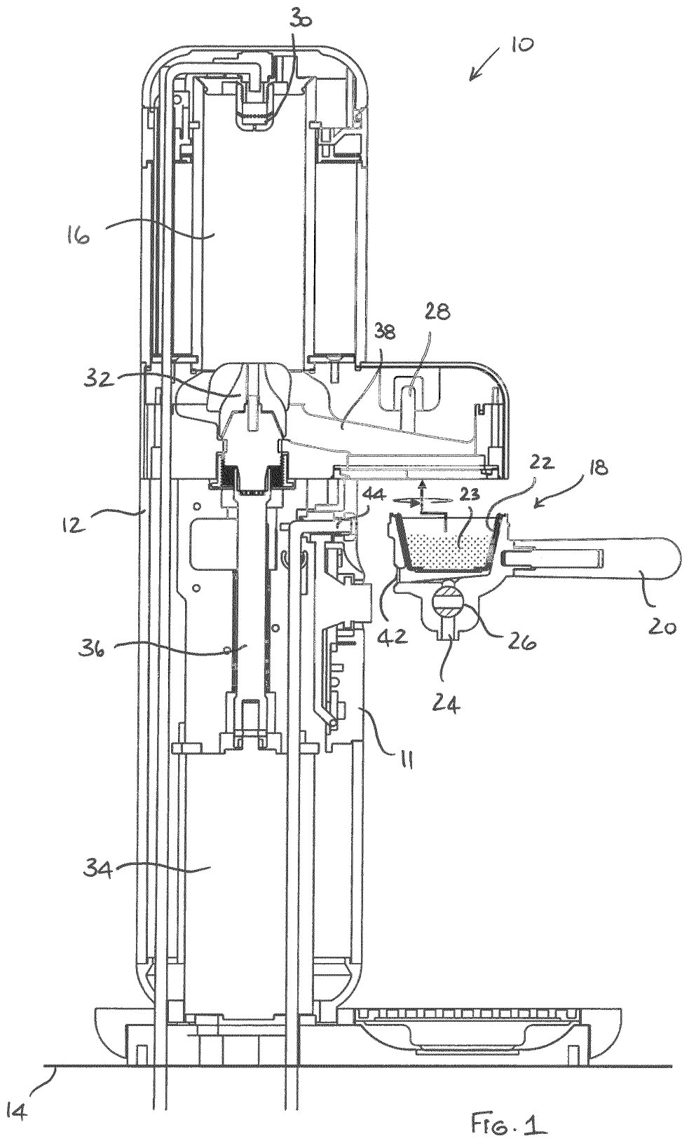

Referring to FIGS. 1 to 8, a first embodiment of a brewing apparatus 10 for producing a beverage, such as cold-brewed tea or cold-brewed coffee, comprises a housing 12 that is positioned in use on a counter 14 or similar surface in a domestic or commercial setting and a control unit 11 for controlling the operation of the apparatus 10. The apparatus 10 comprises a brewing chamber 16 at an upper end of the housing 12 and a filter device 18 which can be removably attached to the housing 12 at a location below the brewing chamber 16. The filter device 18 is typically a portafilter having a handle 20 and can be attached to, and detached from, the housing 12 by a rotational movement. The filter device 18 includes a filter element 22 and a beverage outlet 24 below the filter element 22 which can be selectively opened and closed by a beverage outlet valve 26 which is shown in the closed position in FIG. 1.

Flavour materials 23, for example plant materials such as tea (e.g. tea leaves), coffee (e.g. ground coffee beans), herbs or spices, are loaded in the filter device 18 by a user when the beverage outlet valve 26 is in the closed position and before the filter device 18 is attached to the housing 12. In order to produce a single-serve beverage, 2 to 15 g of flavour materials 23 may be loaded in the filter device 18 but it will be understood that other quantities of flavour materials 23 can be used depending on the desired quantity (e.g. multiple serves) and flavour characteristics of the beverage.

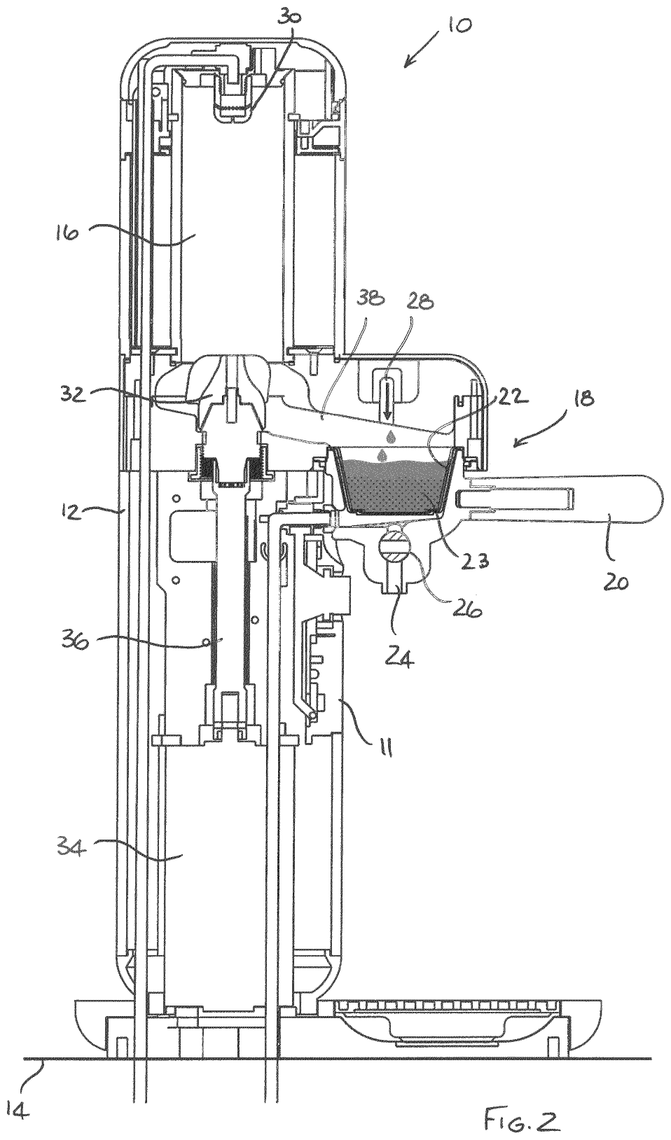

After the filter device 18 has been attached to the housing 12 as shown in FIG. 2, the control unit 11 operates a hot water supply to supply hot water or steam, via a hot water inlet 28, to the filter device 18 so that the flavour materials 23 loaded in the filter device 18 are steeped in the hot water or steam. Typically, 20 to 80 ml of hot water is supplied via the hot water inlet 28 to produce a single-serve beverage based on the above-mentioned quantity of flavour materials 23. The hot water or steam typically has a temperature between 40° C. and 100° C. and the flavour materials 23 are steeped for a relatively short period of time typically between 5 and 30 seconds. During the steeping process, the flavour materials 23 absorb moisture from the hot water or steam and this promotes the initial release of flavour substances from the flavour materials 23. The hot water or steam also helps to reduce microbial contamination (if any) of the flavour materials 23.

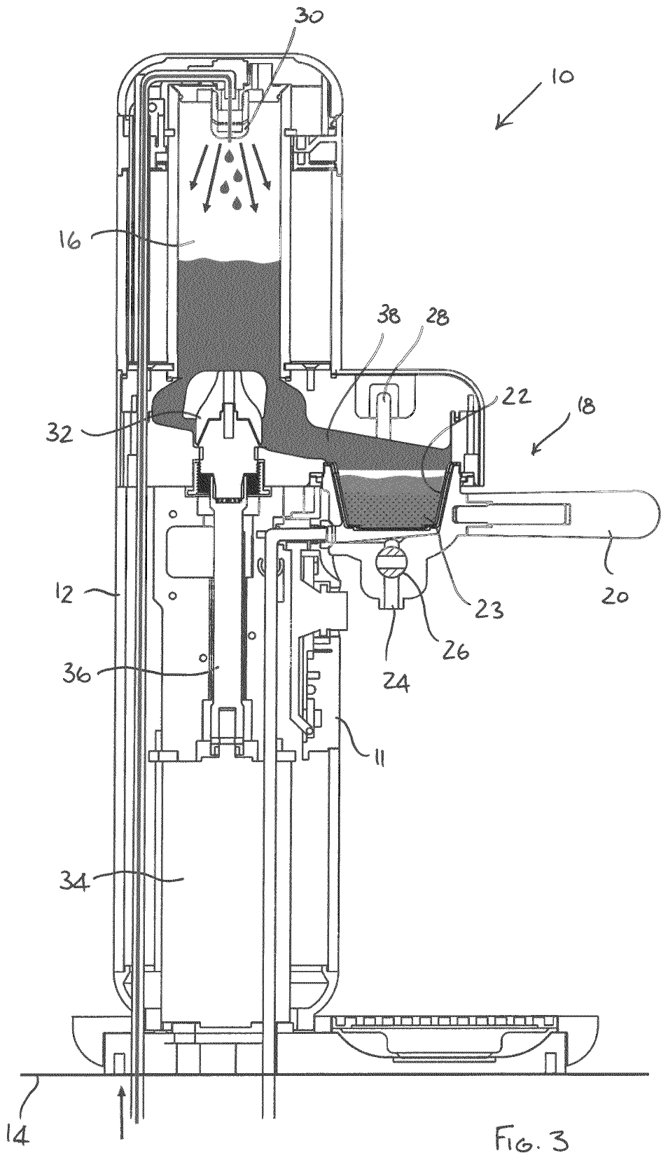

Referring now to FIG. 3, after the flavour materials 23 have been steeped in the filter device 18, the control unit 11 operates a cold water supply to introduce cold water at a temperature typically between 2° C. and 20° C. into the brewing chamber 16 via a cold water inlet 30 located at an upper end of the brewing chamber 16. Typically, 250 to 400 ml of cold water is introduced into the brewing chamber 16 via the cold water inlet 30 to produce a single-serve beverage based on the above-mentioned quantity of flavour materials 23 and hot water.

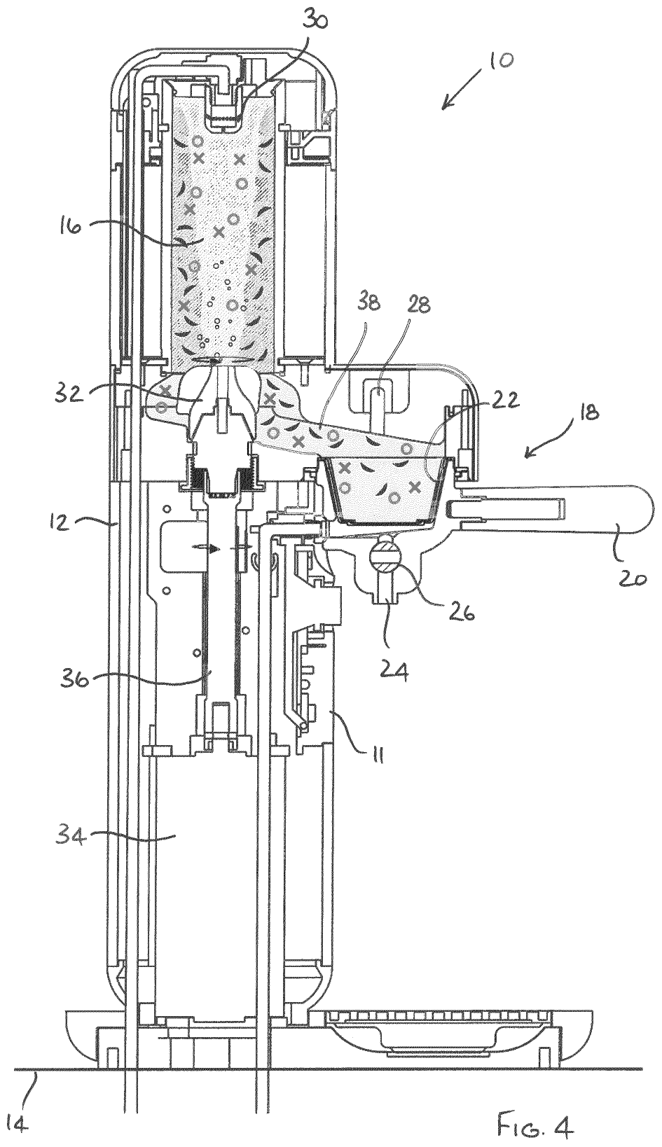

The apparatus 10 comprises a rotary device in the form of an impeller 32 which is located inside the brewing chamber 16 at a lower end thereof and which is connected to an electric motor 34 via a shaft 36. The control unit 11 is operable to actuate the electric motor 34 to rotate the shaft 36, and hence the impeller 32, at a speed typically between 2,000 and 3,000 rpm for a duration of 20 to 60 seconds. As best seen in FIG. 4, the high-speed rotation of the impeller 32 draws the steeped flavour materials 23 upwardly from the filter device 18 along a connecting passage 38 and into the brewing chamber 16. In the illustrated embodiment, residual hot water not absorbed by the flavour materials 23 is also drawn upwardly into the brewing chamber 16 with the steeped flavour materials, although in other embodiments any residual hot water can be drained before rotation of the impeller 32 commences. The resultant mixture of the steeped flavour materials 23, residual hot water (if present) and cold water is circulated in the brewing chamber 16 as shown diagrammatically in FIG. 4 such that pressure variations are induced in the mixture. As noted above, the pressure variations may induce the formation of microbubbles and/or vacuum pockets in the mixture to promote the release of flavour substances. In some embodiments, the pressure variations may be sufficient to cavitate the mixture in the brewing chamber 16.

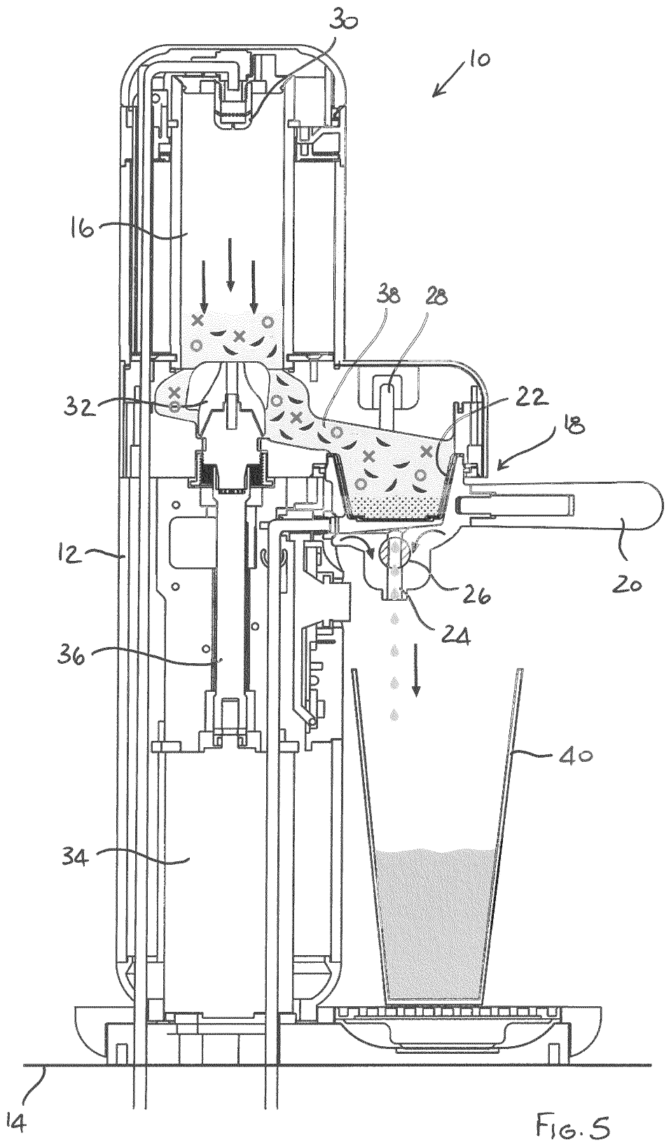

Referring now to FIG. 5, after the electric motor 34 has been deactivated by the control unit 11 and rotation of the impeller 32 has ceased, the beverage outlet valve 26 is opened, either manually or by the control unit 11, to dispense the mixture from the brewing chamber 16 to provide the beverage. The mixture flows under the action of gravity from the brewing chamber 16 through the connecting passage 38 to the filter device 18 and exits the filter device 18 via the beverage outlet 24 where it is dispensed into a receptacle 40 positioned below the beverage outlet 24. It will be understood that the solid flavour materials within the mixture are trapped by the filter element 22 as the mixture passes through it thereby ensuring that only the liquid component of the mixture is dispensed via the beverage outlet 24 into the receptacle 40 to produce the beverage.

After the liquid component of the mixture has been dispensed from the brewing chamber 16 to produce the beverage, it is anticipated that some residual solid flavour materials 23 and/or residual liquid beverage may remain in the brewing chamber 16 and the connecting passage 38, for example attached to the interior surfaces of the brewing chamber 16 and the connecting passage 38, and attached to other components, such as the impeller 32, inside the brewing chamber 16. In order to remove the residual solid flavour materials 23 and/or residual liquid beverage, it is desirable to perform a cleaning cycle in which water and/or steam is/are circulated through the brewing chamber 16 to clean the brewing chamber 16. It will be understood that circulating water and/or steam through the brewing chamber 16 allows any residual solid flavour materials 23 and/or residual liquid beverage to be removed from the brewing chamber 16 before a subsequent brewing cycle is performed.

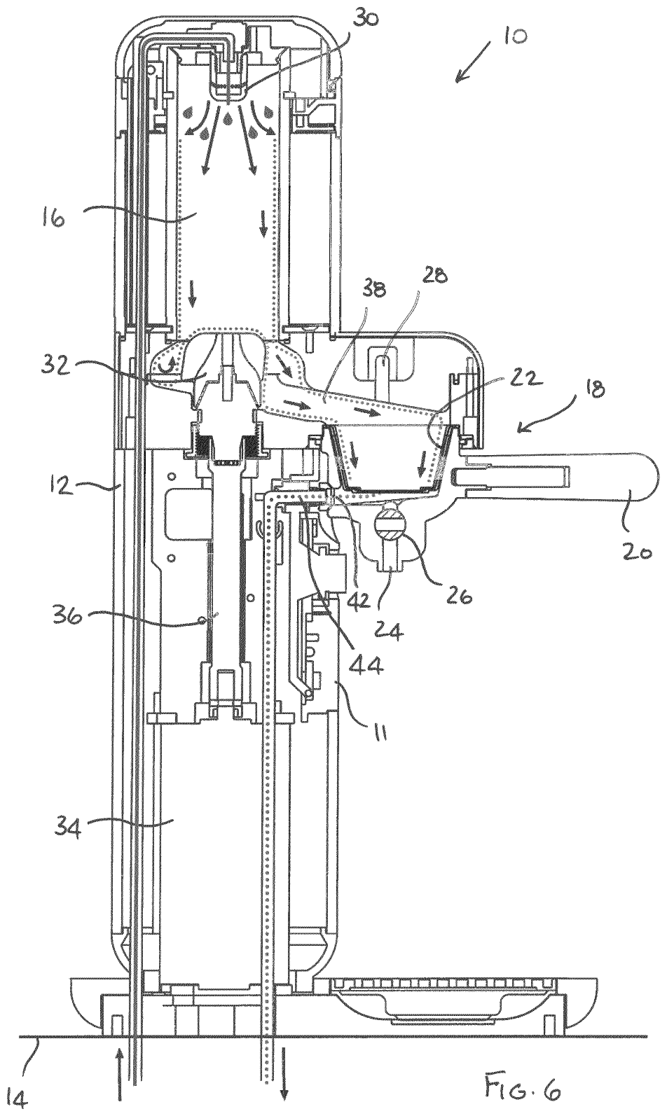

Referring to FIG. 6, in a first embodiment the beverage outlet valve 26 is closed either manually or automatically by the control unit 11 at the end of a brewing cycle after the beverage has been dispensed into the receptacle 40. The filter device 18 includes a further outlet valve 42 which is aligned with an outlet passage 44 in the housing 12. The further outlet valve 42 is opened by the control unit 11 before the control unit 11 operates the cold water supply to introduce cold water into the brewing chamber 16 through the cold water inlet 30. As can be clearly seen in FIG. 6, the cold water, which acts as rinse water, flows under the action of gravity, downwardly from the top of the brewing chamber 16, through the connecting passage 38 and through the filter device 18, and carries residual flavour materials 23 and/or residual liquid beverage to the filter device 18 where any residual flavour materials 23 are trapped by the filter element 22. The rinse water exits the filter device 18 through the further outlet valve 42 and the outlet passage 44. The filter device 18 is subsequently detached from the housing 12 to enable it to be cleaned in any suitable manner, for example by rinsing under a tap, before it is reattached to the housing 12 in readiness for the next brewing cycle.

In a second embodiment, the beverage outlet valve 26 is closed either manually or automatically by the control unit 11 at the end of a brewing cycle after the beverage has been dispensed into the receptacle 40. The filter device 18 is then detached from the housing 12 and cleaned in any suitable manner, for example by rinsing under a tap, before it is reattached to the housing 12. After the filter device 18 has been reattached to the housing 12, the further outlet valve 42 is opened by the control unit 11 before the control unit 11 operates the cold water supply to introduce cold water into the brewing chamber 16 through the cold water inlet 30. As discussed above, the cold water, which acts as rinse water, flows under the action of gravity, downwardly from the top of the brewing chamber 16, through the connecting passage 38 and through the filter device 18, where any residual flavour materials 23 removed by the rinse water are trapped by the filter element 22. The rinse water then exits the filter device 18 through the further outlet valve 42 and the outlet passage 44. The filter device 18 is then detached from the housing 12 for a second time to enable it to be cleaned in any suitable manner, for example by rinsing under a tap, before it is reattached to the housing 12 in readiness for the next brewing cycle.

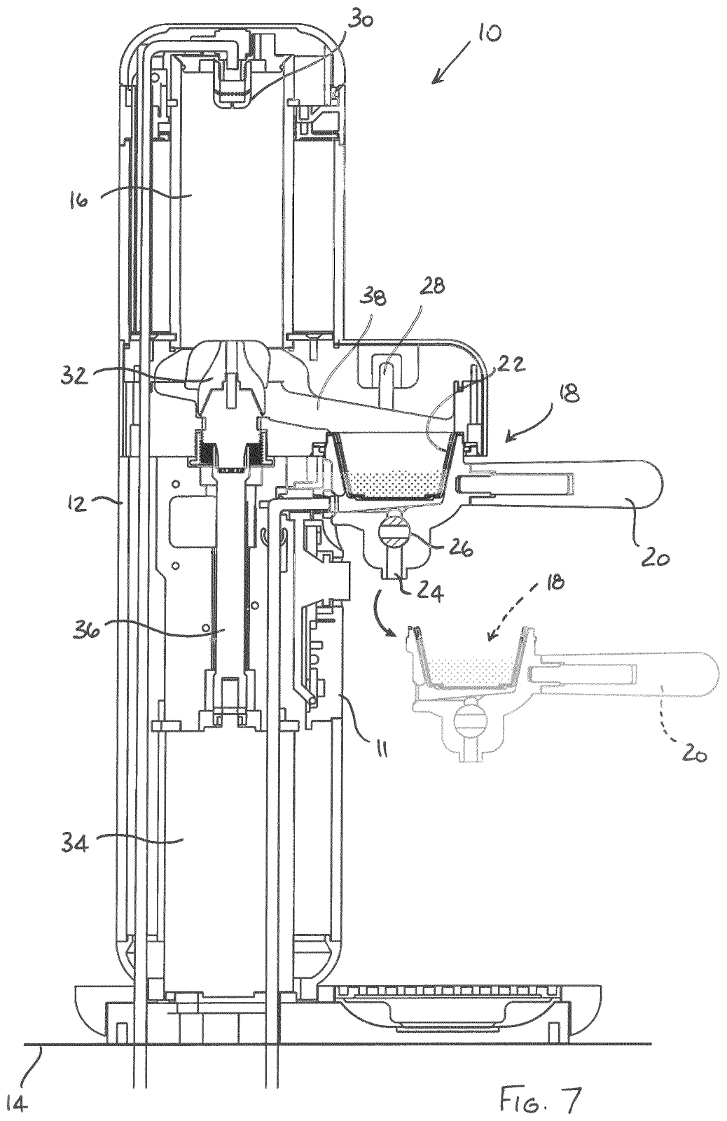

Referring to FIG. 7, in a third embodiment, the beverage outlet valve 26 is closed either manually or automatically by the control unit 11 at the end of a brewing cycle after the beverage has been dispensed into the receptacle 40. The filter device 18 is then detached from the housing 12 so that it can be cleaned in any suitable manner, for example by rinsing under a tap. Prior to re-attaching the filter device 18, a cleaning filter 46 is attached to the housing 12 as shown in FIG. 8. After the cleaning filter 46 has been attached to the housing 12, the control unit 11 operates the cold water supply to introduce cold water into the brewing chamber 16 through the cold water inlet 30. The cold water, which acts as rinse water, flows under the action of gravity, downwardly from the top of the brewing chamber 16, through the connecting passage 38 and through the cleaning filter 46. The cleaning filter 46 may include a filter element (not shown) to trap any residual flavour materials 23 as the rinse water flows through it, but this can be omitted as shown in FIG. 8. The rinse water, and optionally the residual flavour materials 23 if the cleaning filter 46 does not include a filter element, exit(s) the cleaning filter 46 through a drain hole 48 into the outlet passage 44. The cleaning filter 46 is then detached from the housing 12 to enable the filter device 18 to be reattached to the housing 12 in readiness for the next brewing cycle.

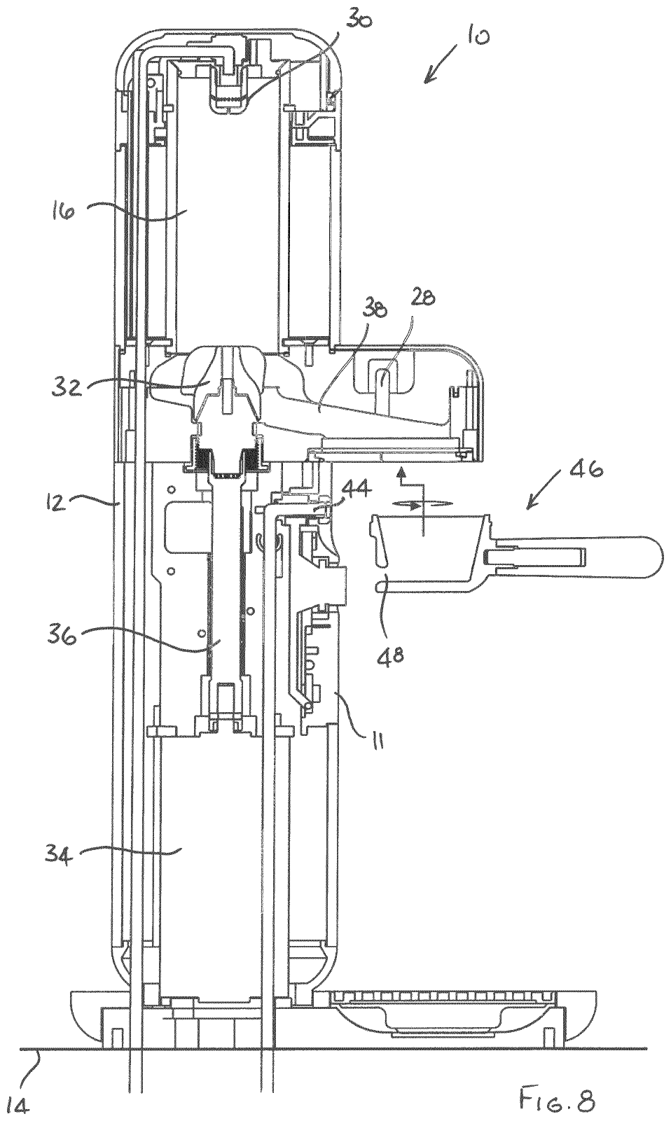

Referring now to FIGS. 9 to 18, there is shown a second embodiment of a brewing apparatus 50 for producing a beverage, such as cold-brewed tea or coffee, which is similar to the brewing apparatus 10 described above with reference to FIGS. 1 to 8 and in which corresponding components are designated using the same reference numerals.

The apparatus 50 comprises a housing 12 that is positioned in use on a counter (not shown) or similar surface in a domestic or commercial setting and a control unit 11 for controlling the operation of the apparatus 50. The apparatus 50 includes a brewing chamber 16 and a filter device 18 which can be removably attached to the housing 12 at a location directly below the brewing chamber 16. The filter device 18 (e.g. a portafilter) has a handle 20 and can be attached to, and detached from, the housing 12 by a rotational movement. The filter device 18 includes a filter element (not shown) and a beverage outlet 24 below the filter element 22 which can be selectively opened and closed by a beverage outlet valve 26 which is shown in the closed position in FIG. 9. In the illustrated embodiment, the beverage outlet 24 includes a dispense conduit 52.

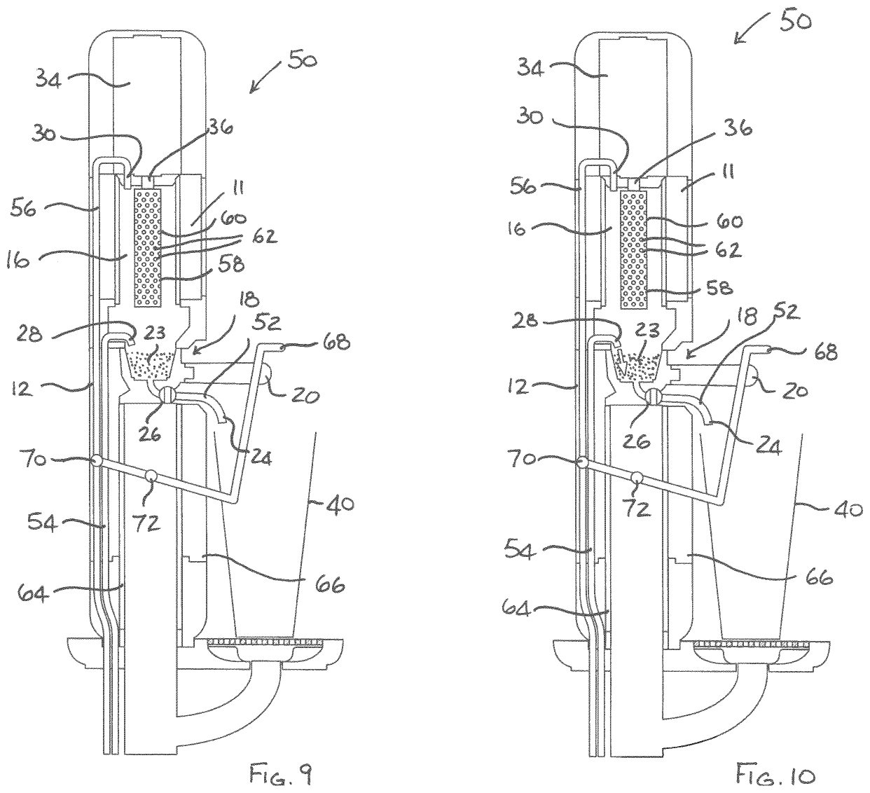

Flavour materials 23, for example of the type described above and in the amount described above, are loaded in the filter device 18 by a user when the beverage outlet valve 26 is in the closed position and before the filter device 18 is attached to the housing 12. After the filter device 18 has been attached to the housing 12 as shown in FIG. 9, the control unit 11 operates a hot water supply as shown in FIG. 10, to supply hot water or steam, via a first supply conduit 54 having a hot water inlet 28, to the filter device 18 so that the flavour materials 23 loaded in the filter device 18 are steeped in the hot water or steam, as shown in FIG. 11. The volume and temperature of the hot water or steam are as described above and the flavour materials 23 are steeped for a relatively short period of time, typically between 5 and 30 seconds. During this steeping process, the flavour materials 23 absorb moisture from the hot water or steam and this promotes the initial release of flavour substances from the flavour materials 23.

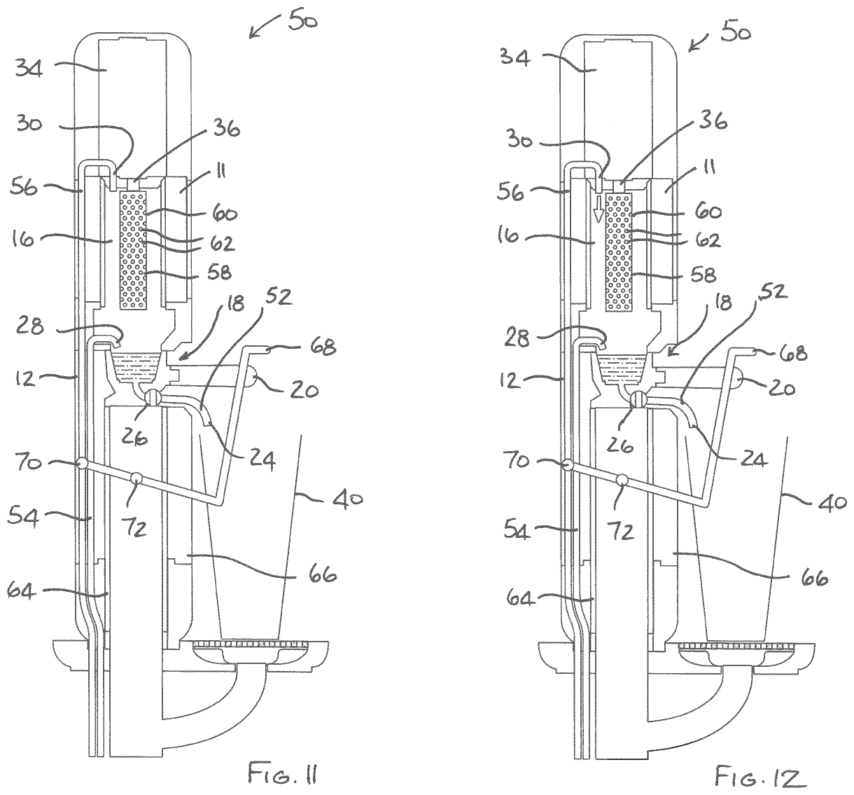

After the flavour materials 23 have been steeped in the filter device 18, as shown in FIGS. 12 and 13 the control unit 11 operates a cold water supply to introduce cold water into the brewing chamber 16 via a second supply conduit 56 having a cold water inlet 30 located at an upper end of the brewing chamber 16. The volume and temperature of the cold water introduced into the brewing chamber 16 are as described above.

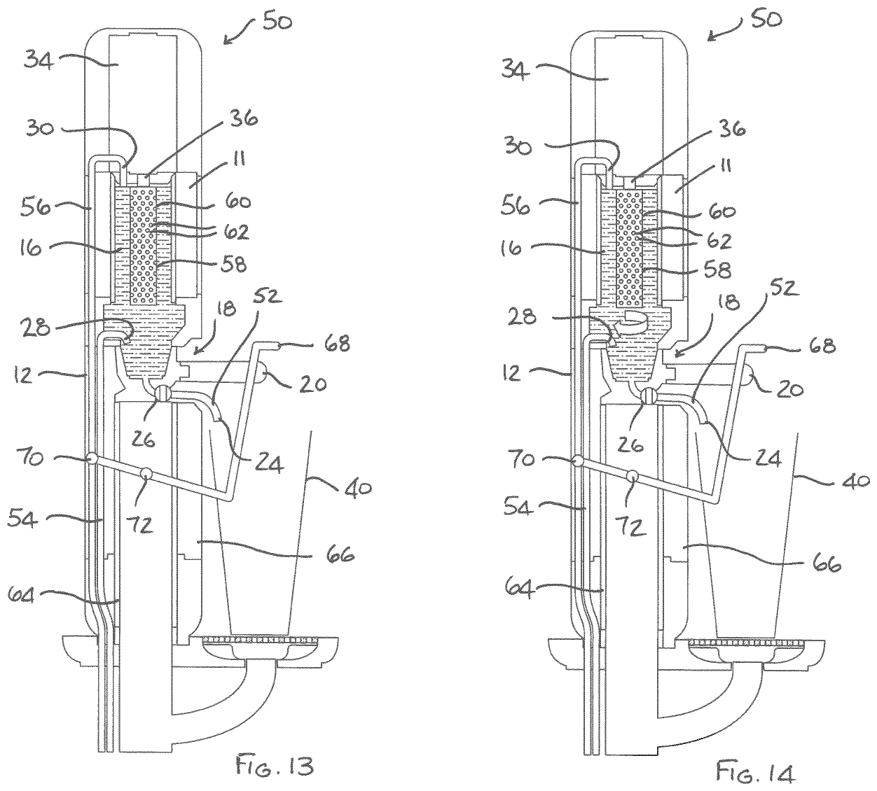

The apparatus 50 comprises a rotary device in the form of a cylindrical drum 58 which is located inside the brewing chamber 16 and which is connected to an electric motor 34 positioned above the cylindrical drum 58 via a shaft 36. The cylindrical drum 58 has a circumferentially extending drum wall 60 including a plurality of apertures or perforations 62. The apertures or perforations 62 are distributed uniformly across the drum wall 60 and may extend in the radial direction through the drum wall 60 to allow the mixture in the brewing chamber 16 to flow between the interior and exterior of the cylindrical drum 58. The control unit 11 is operable to actuate the electric motor 34 to rotate the shaft 36, and hence the cylindrical drum 58, as shown diagrammatically in FIG. 14, e.g., at a speed typically between 2,000 and 3,000 rpm for a duration of 20 to 60 seconds, such that pressure variations are induced in the mixture. As noted above, the pressure variations may induce the formation of microbubbles and/or vacuum pockets in the mixture to promote the release of flavour substances and, in some embodiments, the pressure variations may be sufficient to cavitate the mixture in the brewing chamber 16.

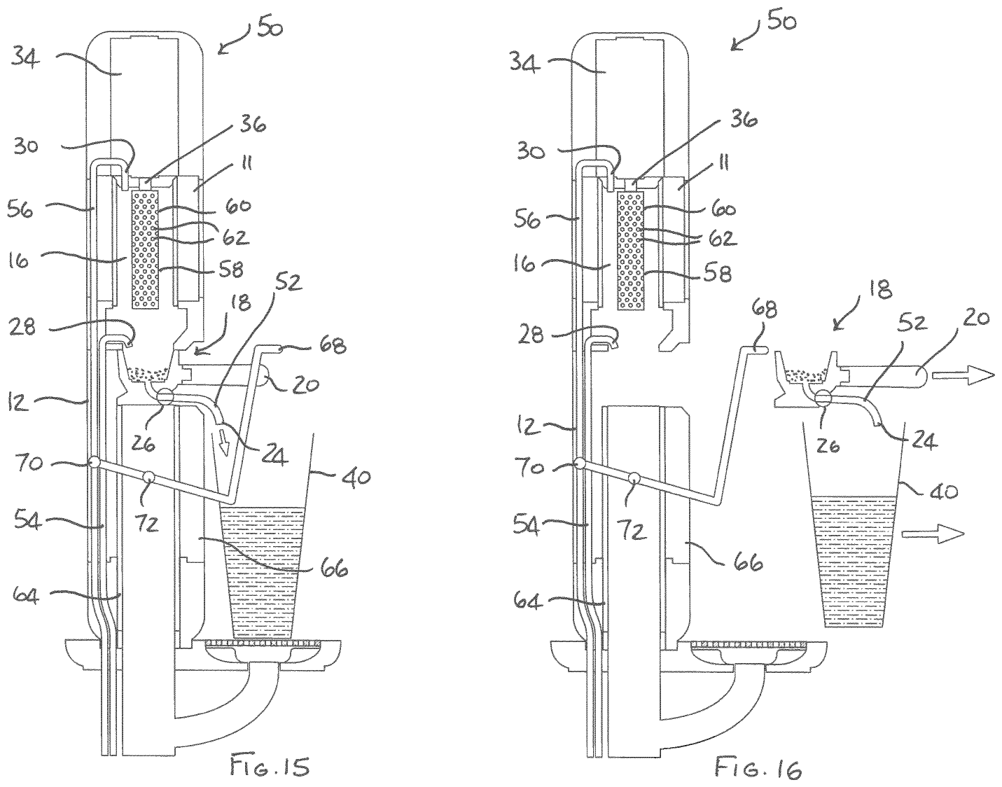

Referring now to FIG. 15, after the electric motor 34 has been deactivated by the control unit 11 and rotation of the cylindrical drum 58 has ceased, the beverage outlet valve 26 is opened, either manually or by the control unit 11, to dispense the mixture from the brewing chamber 16 to provide the beverage. The mixture flows under the action of gravity from the brewing chamber 16 through the filter device 18 and along the dispense conduit 52 where it is dispensed into a receptacle 40 positioned below the beverage outlet 24. As explained above, the solid flavour materials within the mixture are trapped by the filter element 22 as the mixture passes through it thereby ensuring that only the liquid component of the mixture is dispensed via the beverage outlet 24 into the receptacle 40 to produce the beverage.

After the liquid component of the mixture has been dispensed from the brewing chamber 16 to produce the beverage, it is anticipated that some residual solid flavour materials 23 and/or residual liquid beverage may remain in the brewing chamber 16 and/or attached to other components, such as the cylindrical drum 58. In order to remove the residual solid flavour materials 23 and/or residual liquid beverage, it is desirable to perform a cleaning cycle in which water is circulated through the brewing chamber 16 to clean the brewing chamber 16 and other components. As explained above, circulating water through the brewing chamber 16 allows any residual solid flavour materials 23 and/or residual liquid beverage to be removed from the brewing chamber 16 before a subsequent brewing cycle is performed.

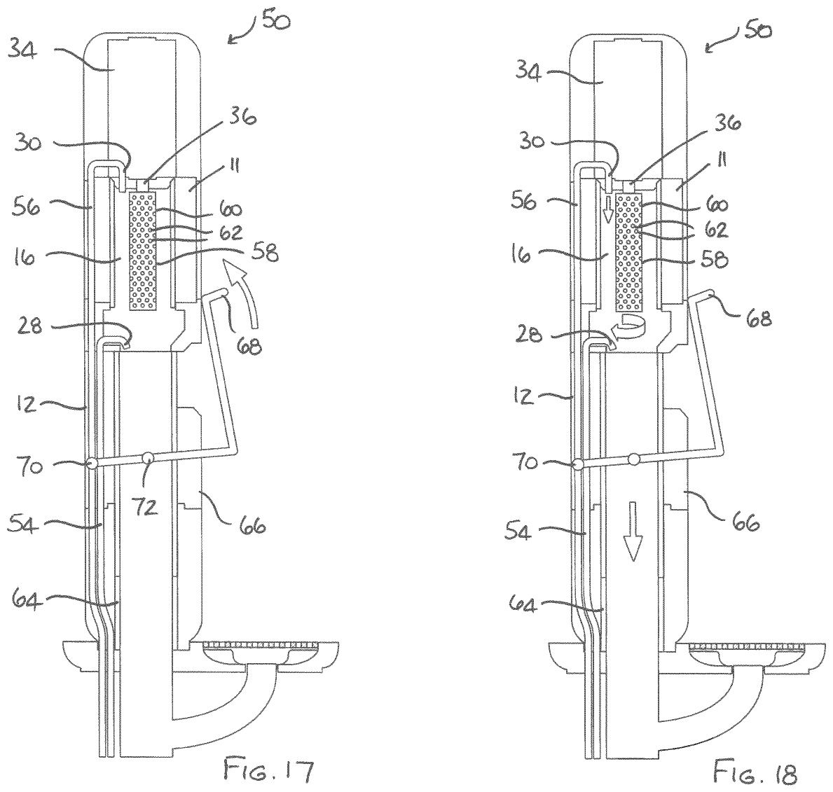

The cleaning cycle is performed by initially detaching the filter device 18 from the housing 12 as shown in FIG. 16. As explained above, the filter device 18 can be cleaned in any suitable manner, for example by rinsing under a tap. The apparatus 50 includes a waste pipe 64 positioned below the brewing chamber 16 which can be moved vertically (after detaching the filter device 18) between a first position shown in FIG. 16 and a second position shown in FIG. 17.

In more detail, the waste pipe 64 is slidably mounted on a lower part 66 of the housing 12 for vertical movement between the first and second positions. The brewing apparatus 50 includes a manually operable actuator, e.g., in the form of a handle 68, which is pivotally connected to opposite sides of the housing 12 by first pivotal connections 70 (only one of which is shown in the figures) and which is pivotally connected to opposite sides of the waste pipe 64 by second pivotal connections 72 (only one of which is shown in the figures). As will be apparent from a comparison of FIGS. 16 and 17, upward movement of the handle 68 by a user causes the handle 68 to rotate about the first pivotal connections 70 in an anti-clockwise direction as viewed in the figures. This in turn moves the waste pipe 64 upwards in the vertical direction from the first position shown in FIG. 16 to the second position shown in FIG. 17. When the waste pipe 64 is in the second position, an upper end of the waste pipe 64 contacts the housing 12 so that the brewing chamber 16 is fluidly connected to the waste pipe 64. It will be understood that the space previously occupied by the filter device 18 is now occupied by the upper part of the waste pipe 64.

The control unit 11 then operates the cold water supply as shown in FIG. 18 to introduce cold water into the brewing chamber 16 via the first supply conduit 54 and through the cold water inlet 30 and actuates the electric motor 34 to rotate the cylindrical drum 58. The cold water, which acts as rinse water, flows downwardly from the top of the brewing chamber 16 and through the cylindrical drum 58 to remove any residual flavour materials 23 from the brewing chamber 16 and the cylindrical drum 58. The rotation of the cylindrical drum 58 may advantageously help to dislodge any residual flavour materials 23 from the drum surfaces and the apertures 62. The rinse water then passes from the brewing chamber 16 into the waste pipe 64 so that it can be removed from the apparatus 50, thereby completing the cleaning cycle.

After the cleaning cycle has been performed and the cold water supply deactivated by the control unit 11, the handle 68 can be moved downwardly by a user. As will be understood, downward movement of the handle 68 by a user causes the handle 68 to rotate about the first pivotal connections 70 in a clockwise direction as viewed in the figures. This in turn moves the waste pipe 64 downwards in the vertical direction from the second position shown in FIG. 18 to the first position shown in FIG. 9. After the waste pipe 64 has been moved to the first position, the filter device 18, loaded with flavour materials 23, can be reattached to the housing 12 in readiness for the next brewing cycle.

In one example, the apparatus 50 could include biasing means (not shown), such as one or more springs, which may be operable to urge the waste pipe 64 in the vertically upwards direction from the first position shown in FIG. 16 to the second position shown in FIG. 17. In this example, it will be understood that a user may not need to move the handle 68 upwardly to move the waste pipe 64 from the first position to the second position or may only need to apply a reduced upward force to the handle 68, because the waste pipe 64 will be urged upwardly by the biasing means after removal of the filter device 18.

Although exemplary embodiments have been described in the preceding paragraphs, it should be understood that various modifications may be made to those embodiments without departing from the scope of the appended claims. Thus, the breadth and scope of the claims should not be limited to the above-described exemplary embodiments.

For example, the filter device 18 may be attached to the housing 12 at a first location, remote from the brewing chamber 16, at which the flavour materials 23 are exposed to hot water and/or steam to steep the flavour materials 23. The filter device 18 may then be detached from the housing at the first location and attached to the housing 12 at a second location in communication with the brewing chamber 16 via the connecting passage 38. The brewing apparatus 10 can then be operated by the control unit 11 in the manner described above so that the steeped flavour materials 23 are mixed with cold water in the brewing chamber 16.

Any combination of the above-described features in all possible variations thereof is encompassed by the present disclosure unless otherwise indicated herein or otherwise clearly contradicted by context.

Unless the context clearly requires otherwise, throughout the description and the claims, the words “comprise”, “comprising”, and the like, are to be construed in an inclusive as opposed to an exclusive or exhaustive sense; that is to say, in the sense of “including, but not limited to”.

1. A method for producing a beverage, the method comprising:
(i) exposing flavour materials to hot water and/or steam to steep the flavour materials;
(ii) circulating a mixture of the steeped flavour materials and cold water in a brewing chamber; and
(iii) dispensing the mixture through a filter device to provide the beverage.

2. A method according to claim 1, wherein the hot water or steam has a temperature between 40° C. and 100° C.

3. A method according to claim 1, wherein the cold water has a temperature between 2° C. and 20° C.

4. A method according to claim 1, wherein step (i) further comprises draining residual hot water after steeping the flavour materials.

5. A method according to claim 1, wherein step (ii) comprises circulating a mixture of the steeped flavour materials, hot water and cold water in the brewing chamber.

6. A method according to claim 1, wherein step (i) comprises exposing the flavour materials to hot water in an amount from 5 to 40 vol. % of the total water content of the beverage.

7. A method according to claim 1, wherein step (ii) is performed using cold water in an amount from 60 to 95 vol. % of the total water content of the beverage.

8. A method according to claim 1, wherein the beverage comprises from 4 to 35 grams of flavour materials per litre of water.

9. A method according to claim 1, wherein step (i) comprises exposing the flavour materials to the hot water or steam for a period of 5 to 60 seconds.

10. A method according to claim 1, wherein step (ii) comprises inducing pressure variations in the mixture in the brewing chamber.

11. A method according to claim 1, wherein step (ii) comprises cavitating the mixture in the brewing chamber.

12. A method according to claim 1, wherein step (ii) comprises circulating the mixture for 10 to 150 seconds.

13. A method according to claim 1, wherein step (ii) comprises circulating the mixture using a rotary device.

14. (canceled)

15. A method according to claim 1, wherein the method further comprises, prior to step (i), exposing the flavour materials to cold water.

16. A method according to claim 15, wherein the cold water has a temperature between 2° C. and 20° C.

17. A method according to claim 1, wherein the method further comprises:
(iv) circulating water and/or steam through the brewing chamber to clean the brewing chamber.

18. A method according to claim 1, wherein the method comprises loading the flavour materials into the filter device and step (i) comprises exposing the flavour materials in the filter device to the hot water or steam to steep the flavour materials.

19. A method according to claim 18, wherein the method comprises positioning the filter device at a location in communication with the brewing chamber and performing steps (i) to (iii) at said location.

20. A method according to claim 19, wherein the method comprises positioning the filter device at a first location, remote from the brewing chamber, and performing step (i) at the first location and repositioning the filter device containing the steeped flavour materials at a second location, in communication with the brewing chamber, and performing steps (ii) and (iii) at the second location.

21. An apparatus for producing a beverage, the apparatus comprising a hot water supply, a brewing chamber including a circulating device, a filter device and a control unit, wherein the control unit is operable to:
operate the hot water supply to expose flavour materials to hot water and/or steam to steep the flavour materials; and
operate the circulating device to circulate a mixture of the steeped flavour materials and cold water in the brewing chamber;
wherein the apparatus is arranged to dispense the mixture through the filter device to provide the beverage.

22. (canceled)
